(19) United States
(12) Patent Application Publication
(10) Pub. No.: US 2005/0226581 A1
(43) Pub. Date: Oct. 13, 2005

(54) Optical fibre with mechanically reinforced coating

(76) Inventors: Antonio Carrus, Monza (IT); Antonio Zaopo, Milano (IT); Antonio Campana, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/498,867

(22) PCT Filed: Dec. 18, 2001
(86) PCT No.: PCT/IB01/02524

§ 371 Date: May 5, 2005

(51) Int. Cl. G02B 6/22

(52) U.S. Cl. 385/128; 385/114

(57) ABSTRACT

Optical fibre having a glass portion and at least one coating of crosslinked polymer material surrounding the glass portion, the coating being obtained by crosslinking a mixture of at least one crosslinkable liquid composition having at least one oligomer containing at least one reactive functional group, at least one diluent monomer capable of reacting with the reactive functional group and at least one photo-initiator; at least one inorganic material with lamellar structure formed by a plurality of lamellae that have been surface-treated beforehand with a compatibilizer. The coating is formed by the crosslinked liquid composition intercalated between the lamellae of the inorganic material. Preferably, the coating is a secondary coating or, in the case of a ribbon of optical fibres, it is a common polymer coating known as a “common coating.”

The present invention relates to an optical fibre comprising at least one mechanically reinforced coating layer.

More particularly, the present invention relates to an optical fibre comprising a glass portion and at least one coating of crosslinked polymer material surrounding said glass portion, said coating being obtained by crosslinking a mixture comprising at least one crosslinkable liquid composition and at least one inorganic material with lamellar structure and a polymer material that may be applied as said-coating.

Optical fibres commonly consist of a glass portion (typically with a diameter of about 125 μm), inside which the transmitted optical signal is confined, and of a coating, typically polymeric, surrounding the glass portion for essentially protective purposes. This protective coating typically comprises a first layer of coating positioned directly on the glass surface, known as the “primary coating” or “primary” for short, typically having a thickness of between about 25 μm and about 35 μm. In turn, this primary coating is generally covered with a second layer of coating, known as the “secondary coating” or “secondary” for short, typically having a thickness of between about 10 μm and about 30 μm.

These polymer coatings may be obtained from crosslinkable compositions comprising oligomers and monomers that are generally crosslinked by means of UV irradiation in the presence of a suitable photo-initiator. The two coatings described above differ, inter alia, in terms of the modulus of elasticity of the crosslinked material. As a matter of fact, whereas the material which forms the primary coating is a relatively soft material, with a relatively low modulus of elasticity at room temperature, the material which forms the secondary coating is relatively harder, having higher modulus of elasticity values at room temperature. The combination of said two layers of coating ensures adequate mechanical protection for the optical fibre.

The optical fibre thus composed has a total diameter of about 250 μm. However, for particular applications, this total diameter may also be smaller; in this case, a coating of reduced thickness is generally applied.

The optical fibres can optionally be combined in groups of several fibres, typically in the form of ribbons of optical fibres, for the purpose of facilitating their insertion into a cable. Typically, from 4 to 24 optical fibres are arranged in parallel to form a ribbon of optical fibres and are covered with a single polymer coating, known as a “common coating”, the composition and physical properties of which are similar to those of the secondary coating.

It has been suggested to mechanically reinforce such coating layers by adding, for example, inorganic fillers.

As observed by the Applicant, it is possible to improve the mechanical properties of such coatings by suitably mixing the abovementioned crosslinkable compositions with a suitable inorganic material with lamellar structure.

Patent application EP 1 052 534 describes an optical cable comprising at least one optical fibre and at least one coating comprising a material that includes an organic compound and a inorganic compound with lamellar structure, characterized in that said organic compound is intercalated between the lamellae of said inorganic compound. In particular, said patent application describes the use of said coating as an outer coating for an optical cable and suggests producing said coating by mechanically mixing this organic compound with the inorganic compound at a temperature above the softening point or melting point of the organic compound. Said patent application also suggests that such a coating, obtained in a similar manner, can be used as a coating for an optical fibre.

The Applicant has found, however, that the use of an organic compound and a inorganic material with lamellar structure does not always make it possible to obtain a material in which said organic compound is intercalated between the lamellae of said inorganic compound. In particular, the Applicant has observed that subjecting a crosslinkable liquid composition and an inorganic material with lamellar structure to mechanical mixing does not produce the desired degree of intercalation and, consequently, the material obtained does not have the desired properties. As observed by the Applicant, a sufficient degree of intercalation of said crosslinkable liquid composition in said inorganic material is achieved only if the mixture of the two is subjected to a particular treatment.

In particular, the Applicant has found that, in order to obtain the abovementioned degree of intercalation and, thus, the abovementioned desired properties, the crosslinkable liquid composition and the inorganic material must be subjected to an ultrasonic treatment.

The Applicant has thus found that it is possible to obtain an optical fibre of improved properties, in particular improved mechanical properties, by giving said fibre at least one coating of a polymer material obtained by crosslinking a crosslinkable liquid composition intercalated between the lamellae of an inorganic material with lamellar structure. Once the intercalation of the abovementioned crosslinkable liquid composition and the consequent exfoliation of the inorganic material with lamellar structure are complete, a polymer material is obtained in which said inorganic material is homogeneously distributed in the polymer material and has dimensions of the order of a nanometer. The degree of intercalation present in the polymer material that is obtained by intercalating the crosslinkable liquid composition is subsequently found in the crosslinked polymer material.

According to a first aspect, the present invention thus relates to an optical fibre comprising a glass portion and at least one coating of crosslinked polymer material surrounding said glass portion, said coating being obtained by crosslinking a mixture comprising:
at least one crosslinkable liquid composition comprising at least one oligomer containing at least one reactive functional group, at least one diluent monomer capable of reacting with said reactive functional group and at least one photo-initiator;
at least one inorganic material with lamellar structure formed by a plurality of lamellae that have been surface-treated beforehand with a compatibilizer;
   characterized in that said coating is formed by said crosslinked liquid composition intercalated between the lamellae of said inorganic material.

According to one preferred embodiment, said coating is a secondary coating surrounding a primary coating.

According to a further aspect, the present invention relates to a ribbon of optical fibres arranged in parallel and enclosed in a common coating of crosslinked polymer material, said coating being obtained by crosslinking a mixture comprising:
at least one crosslinkable liquid composition comprising at least one oligomer containing at least one reactive functional group, at least one diluent monomer capable of reacting with said reactive functional group and at least one photo-initiator;
at least one inorganic material with lamellar structure formed by a plurality of lamellae that have been surface-treated beforehand with a compatibilizer;
   characterized in that said coating is formed by said crosslinked liquid composition intercalated between the lamellae of said inorganic material.

The optical fibres of said ribbon are in turn coated with a primary coating and with a secondary coating. According to one preferred embodiment, said secondary coating is a coating of crosslinked polymer material as defined above.

According to one preferred embodiment, said coating may be obtained by subjecting said mixture to ultrasonic treatment followed by crosslinking.

According to a further preferred embodiment, said coating may be obtained by subjecting at least said oligomer and said inorganic material with lamellar structure to ultrasonic treatment, mixing the remaining components of the abovementioned crosslinkable liquid composition, and then crosslinking the mixture thus obtained.

According to a further aspect, the present invention relates to a polymer material which may be obtained by ultrasonic treatment and then crosslinking a mixture comprising:
at least one crosslinkable liquid composition comprising at least one oligomer containing at least one reactive functional group, at least one diluent monomer capable of reacting with said reactive functional group and at least one photo-initiator;
at least one inorganic material with lamellar structure formed by a plurality of lamellae that have been surface-treated beforehand with a compatibilizer;
   characterized in that said polymer material is formed by said crosslinked liquid composition intercalated between the lamellae of said inorganic material.

According to one preferred embodiment, said polymer material may be obtained by subjecting at least said oligomer and said inorganic material with lamellar structure to ultrasonic treatment, mixing the remaining components of the abovementioned crosslinkable liquid composition, and then crosslinking the mixture thus obtained.

According to a further aspect, the present invention relates to a method for preparing a crosslinkable polymer material, in which a crosslinkable liquid composition is intercalated between the lamellae of an inorganic compound with lamellar structure, said method comprising the ultrasonic treatment of a mixture comprising:
at least one crosslinkable liquid composition comprising at least one oligomer containing at least one reactive functional group, at least one diluent monomer capable of reacting with said reactive functional group and at least one photo-initiator;
at least one inorganic material with lamellar structure formed by a plurality of lamellae that have been surface-treated beforehand with a compatibilizer.

According to one preferred embodiment, said method may be performed by subjecting at least said oligomer and said inorganic material with lamellar structure to ultrasonic treatment and mixing the remaining components of the abovementioned crosslinkable liquid composition with the mixture thus obtained.

According to one preferred embodiment, said crosslinkable liquid composition comprises at least one oligomer containing at least one (meth)acrylate end group, at least one diluent monomer of acrylic type and at least one photo-initiator.

For the purposes of the present description and the claims hereinbelow, the term “(meth)acrylates” comprises both the acrylic function and the methacrylic function.

According to a further preferred embodiment, the oligomer containing at least one (meth)acrylate end group has a molecular weight of not less than 300 daltons, preferably not less than 400 daltons.

According to one preferred embodiment, the intercalation of said oligomer or of said crosslinkable liquid composition between the lamellae of said inorganic material with lamellar structure is such that it produces, in the polymer material obtained, a d-spacing value by X-ray diffraction analysis that is at least 20%, preferably at least 30%, up to, for example, 120%, greater than the d-spacing value of the inorganic material that has been surface-treated beforehand with a compatibilizer per se.

For the purposes of the present invention, the variations (%) of the d-spacing values were calculated by X-ray diffraction analysis. The analysis was obtained by placing the test samples (the samples were obtained by working as described in the examples hereinbelow) in a “Philips 'Xpert” diffractometer using an analysis radiation of the CuKα type. The data were obtained by a step of 0.04°2θ and a count of 6 seconds per step in the interval 1.4°2θ-32.0°2θ. The d-spacing value was calculated by applying the following formula:
d-spacing=λ/2 sin θ
in which λ is the wavelength of the radiation kα of Cu (average between kα1 and kα2) equal to 1.54178 Å.

The d-spacing value corresponds to the distance between the crystal planes of the polymer material according to the present invention, in particular, said value is the average distance separating the corresponding surfaces of contiguous lamellae of inorganic material. The effective distance between the contiguous lamellae is obtained by subtracting the thickness of a single lamella (about 1 nm) from the d-spacing value.

According to one preferred embodiment, said polymer material has a modulus of elasticity at 70° C. of between 20 MPa and 1000 MPa, preferably between 100 MPa and 700 MPa.

According to a further preferred embodiment, said polymer material has a glass transition temperature (T_{g}) of between 75° C. and 85° C., preferably between 79° C. and 82° C.

Said modulus of elasticity and said glass transition temperature (T_{g}) are measured using DMTA apparatus (Dynamic Mechanical Thermal Analyzer from Reometrics Inc.), in traction with sinusoidal course, working at an oscillation frequency of between 0.033 Hz and 90 Hz and at a temperature interval of between −150° C. and 300° C.: further details regarding the analysis method will be described in the examples given below.

The present invention may be understood more clearly with reference to the following attached figures:

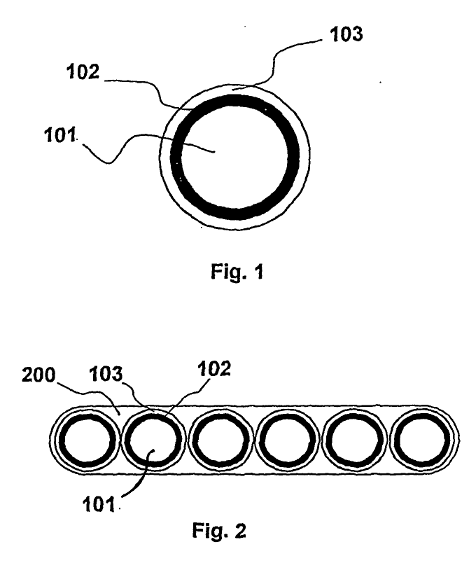

FIG. 1: is a view in cross section of an optical fibre;

FIG. 2: is a view in cross section of a ribbon of optical fibres comprising several optical fibres.

FIG. 1 shows an optical fibre comprising a glass portion (101) covered with a primary coating (102) that may be produced as described below, which is in its turn covered with a secondary coating (103) that may be produced according to the present invention.

FIG. 2 shows several optical fibres of the type given in FIG. 1, combined in the form of a ribbon by means of enclosing them in a common polymer coating (200), known as a “common coating”, which may be produced according to the present invention.

A secondary coating (103) and a common polymer coating (200) according to the present invention may be produced by means of crosslinking a crosslinkable liquid composition comprising an inorganic material with lamellar structure.

Generally, said crosslinkable liquid composition comprises at least one oligomer containing a reactive functional group, at least one diluent monomer capable of reacting with said reactive functional group and at least one photo-initiator. Said reactive functional group generally contains ethylenic unsaturation and may be selected, for example, from the following groups: (meth)acrylates, styrene, vinyl ethers, vinyl esters, N-substituted acrylamides, vinyl amides, maleates, fumarates. Preferably, at least 80 mol %, more preferably at least 90 mol %, relative to the total number of moles of oligomers present in the polymer, even more preferably all of the functional groups present in the oligomer, are (meth)acrylate groups.

In particular, said liquid composition comprises at least one oligomer containing at least one (meth)acrylate end group, at least one diluent monomer of acrylic type and at least one photo-initiator.

The process for crosslinking said composition may be of radical or cationic type or may involve both. The radical process is generally preferred.

The oligomer containing at least one reactive functional group generally represents 40%-80% by weight of the crosslinkable liquid composition. The oligomer commonly consists of a polyurethane acrylate, an epoxy acrylate, or a mixture thereof. The polyurethane acrylate is obtained by reaction between a polyol structure, a polyisocyanate and a monomer bearing a (meth)acrylic function.

The molecular weight of the polyol structure is, for indicative purposes, between 200 daltons and 6000 daltons; it may be entirely of hydrocarbon, polyether, polyester, polysiloxane, fluorinated type, or a mixture thereof. The hydrocarbon and polyether structures and mixtures thereof are preferred. A representative structure of a polyether polyol may be, for example, polytetramethylene oxide, polymethyltetramethylene oxide, polymethylene oxide, polypropylene oxide, polybutylene oxide, isomers thereof, or mixtures thereof. Representative structures of a hydrocarbon polyol are polybutadiene and polyisobutylene, totally or partially hydrogenated and functionalized with hydroxyl groups.

The polyisocyanate may be of aromatic or aliphatic type. Examples of polyisocyanates are: isophorone diisocyanate, 1,6-hexamethylene diisocyanate, 2,2,4-trimethyl-1,5-pentamethylene diisocyanate, 3,3′-diphenylmethane diisocyanate, 4,4′-diphenylmethane diisocyanate, 2,4-toluene diisocyanate, 2,6-toluene diisocyanate.

The monomer bearing the (meth)acrylic function comprises groups capable of reacting with the isocyanic group. Examples that are suitable for this purpose are hydroxyalkyl (meth)acrylates such as, for example, hydroxyethyl (meth)acrylate or hydroxypropyl (meth)acrylate. An epoxyacrylate obtained by reacting acrylic acid with a diglycidyl ether of an alcohol, typically bisphenol A or bisphenol F, may also be used.

Preferably, said oligomer has a molecular weight of not less than 300 daltons, generally between 400 daltons and 10000 daltons, more preferably between 500 daltons and 7000 daltons and even more preferably between 1000 daltons and 5000 daltons.

Without wishing to be bound by any particular interpretive theory, the Applicant believes that the use of oligomers with a molecular weight of less than 300 daltons does not make it possible to obtain the desired degree of intercalation and, consequently, does not allow the desired polymer material to be obtained.

Oligomers that may be used in the present invention are commercially available, for example, under the brand name Ebecryl® from UCB. Ebecryl® 210, Ebecryl® 150 and Ebecryl® 3700 are particularly preferred.

The diluent monomer represents 20%-50% by weight of the crosslinkable liquid composition and its main purpose is to give the crosslinkable composition a viscosity of about 5 Pa.s at coating-application temperature. The diluent monomer, bearing the reactive function, preferably of (meth)acrylic type, has a structure that is compatible with that of the oligomer. The diluent monomer may contain an alkyl structure such as, for example, isobornyl acrylate, hexane diacrylate, 1,6-hexanediol diacrylate, dicyclopentadiene acrylate, trimethylolpropane triacrylate; or an aromatic structure such as, for example, nonylphenyl ether acrylate, polyethylene glycol phenyl ether acrylate, acrylic derivatives of bisphenol A.

The photo-initiator is necessary when the crosslinking is performed by means of irradiation with UV rays. Said photo-initiator, in particular in the case of radical crosslinking is generally selected from the radical photo-initiators known as Norrish Type I and Norrish Type II.

At least one homolytic fragmentation photo-intiator (also known as Norrish Type I), which operates via the cleavage of intramolecular bonds, is preferably present in the crosslinkable composition of the present invention.

Examples of Norrish Type I photo-initiators that may be advantageously used in the present invention may be selected from benzoin derivatives, methylbenzoin derivatives and 4-benzoyl-1,3-dioxolane derivatives, benzyl ketals, (α,α-dialkoxy)acetophenones, (α-hydroxy)alkylphenones, (α-amino)alkylphenones, acylphosphine oxides, acylphosphine sulphides, o-acyl-α-oximino ketones, halogenated acetophenone derivative, benzoyldiarylphosphine oxides. Said photo-initiators may be used as such or mixed together.

Norrish Type 1 photo-initiators that may be used in the present invention and that are commercially available are, for example, Darocur® 1173 (2-hydroxy-2-methyl-1-phenylpropan-1-one as active component) from Ciba, Irgacure® 184 (hydroxycyclohexylphenyl ketone as active component) from Ciba, Irgacure® 907 (2-methyl-1-(4-methylthio)phenyl-2-morpholinopropan-1-one as active component) from Ciba, Irgacure® 369 (2-benzyl-2-dimethylamino-1-(morpholinophenyl)-butanone-1 as active component) from Ciba, acylphosphines such as, for example, Lucirin® TPO (2,4,6-trimethylbenzoyl-diphenylphosphine oxide) from BASF, and Irgacure® 1700 (bis(2,6-dimethoxybenzoyl)-2,2,4-trimethylpentylphosphine oxide) from Ciba.

Examples of Norrish Type II photo-initiators (involving hydrogen abstraction) that may be advantageously used in the present invention may be selected from aromatic ketones such as, for example, benzophenone, xanthone, benzophenone derivatives, Michler ketones, thioxanthones and other xanthone derivatives such as, for example, ITX (isopropyl thioxanthone), or mixtures thereof. The Type II photo-initiators are generally used in the presence of a synergistic amine.

The amount of photo-initiator generally corresponds to 1%-10% by weight of the composition.

For the purpose of improving the fundamental properties of the abovementioned composition, further additives may optionally be added. For example, solvents, plasticizers, inks, colorants, expansion agent, devolatilizers, opacifiers, rheological agents, antioxidants, UV stabilizers that are capable of not interfering with the crosslinking operations, temperature-mediated polymerization inhibitors, levelling agents and detachment promoters as regards subsequent coatings, may be added.

According to one preferred embodiment, the crosslinkable liquid composition comprises about 40%-70% by weight of polyurethane acrylate, epoxy acrylate or a mixture thereof, about 30%-50% by weight of diluent monomer, about 1%-5% by weight of photo-initiator, about 0.5%-5% by weight of other additives.

According to one preferred embodiment, the inorganic material with lamellar structure may be selected from phyllosilicates such as: smectites, for example montmorillonite, nontronite, beidellite, volkonskoite, hectorite, saponite, sauconite; vermiculite; halloysite; sericite; or mixtures thereof. Montmorillonite is particularly preferred.

Said inorganic material with lamellar structure is surface-treated beforehand with a compatibilizer so as to promote the intercalation of the organic compound between the lamellae of said inorganic compound. The amount of compatibilizer used changes the polarity of said inorganic compound.

The compatibilizer may be selected from quaternary ammonium and phosphonium salts of general formula (I): 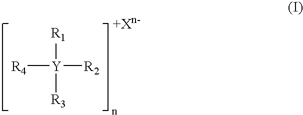
in which:
Y represents N or P;
R₁, R₂, R₃ and R₄, which may be identical or different, represent a linear or branched C₁-C₂₀ alkyl or hydroxyalkyl group; a linear or branched C₁-C₂₀ alkenyl or hydroxyalkenyl group; a group —R₅—SH or —R₅—NH in which R₅ represents a linear or branched C₁-C₂₀ alkylene group; a C₆-C₁₈ aryl group; a C₇-C₂₀ arylalkyl or alkylaryl group; a C₅-C₁₈ cycloalkyl group, said cycloalkyl group optionally containing a hetero atom such as oxygen, nitrogen or sulphur;
Xⁿ⁻ represents an anion such as a chloride ion, a sulphate ion or a phosphate ion;
n represents 1, 2 or 3.

As stated above, the amount of compatibilizer used changes the polarity of the inorganic material with lamellar structure. For example, in order to obtain a low-polarity inorganic material with lamellar structure, said material is treated with an amount of between 125 meq and 200 meq, per 100 g of inorganic material with lamellar structure, of a compatibilizer having the general formula (I) in which at least two of the substituents R₁, R₂, R₃ and R₄ represent a linear or branched C₄-C₂₀, and preferably C₁₈, alkyl group.

Alternatively, in order to obtain a medium-polarity inorganic material with lamellar structure, said material is treated with an amount of between 95 meq and 125 meq, per 100 g of inorganic material with lamellar structure, of a compatibilizer having the general formula (I) in which at least one of the substituents R₁, R₂, R₃ and R₄ represents a linear or branched C₄-C₂₀ alkyl or hydroxyalkyl group or a group —R₅—SH or —R₅—NH in which R₅ represents a linear or branched C₄-C₂₀ alkylene group.

Alternatively, in order to obtain a high-polarity inorganic material with lamellar structure, said material is treated with an amount of between 20 meq and 95 meq, per 100 g of inorganic material with lamellar structure, of a compatibilizer having the general formula (I) in which at least one of the substituents R₁, R₂, R₃ and R₄ represents a linear or branched C₄-C₂₀ alkyl or hydroxyalkyl group, or a linear or branched C₄-C₂₀ alkenyl or hydroxyalkenyl group, or a group —R₅—SH or —R₅—NH in which R₅ represents a linear or branched C₄-C₂₀ alkylene group.

The surface treatment of the inorganic material with lamellar structure with the compatibilizer may be performed according to known techniques such as, for example, by an ion-exchange reaction between the inorganic material with lamellar structure and the compatibilizer: further details are described, for example, in patents U.S. Pat. No. 4,136,103, U.S. Pat. No. 5,747,560 or U.S. Pat. No. 5,952,093.

A person skilled in the art is capable of readily determining the appropriate degree of polarity of the treated inorganic material with lamellar structure relative to the degree of polarity of the organic material to be intercalated between the lamellae, so as to obtain adequate compatibilization.

Preferably, for the purposes of the present invention, a medium-polarity or high-polarity inorganic material with lamellar structure is used. Said material, obtained by surface treatment with an amount of compatibilizer of between 80 meq and 100 meq per 100 g of inorganic material with lamellar structure, is found to be particularly compatible with the components of acrylic type in the composition.

Examples of inorganic materials with lamellar structure that may be used in the present invention and that are commercially available are the products known under the name Cloisite® from Southern Clay Products. Cloisite® 30B is preferred.

The inorganic material with lamellar structure is added in an amount of between 1 phr and 40 phr, preferably between 4 phr and 20 phr.

For the purposes of the present description and the subsequent claims, the term “phr” is intended to indicate the parts by weight of a given ingredient per 100 parts of crosslinkable liquid composition.

The polymer material according to the present invention is obtained by ultrasonic treatment of a mixture comprising at least one crosslinkable liquid composition and at least one inorganic compound with lamellar structure. To this end, the ultrasonic treatment is carried out at a frequency of between 20 KHz and 60 KHz, preferably between 40 KHz and 55 KHz, even more preferably between 45 KHz and 50 KHz, at room temperature, for a period of between 5 minutes and 120 minutes, preferably between 15 minutes and 60 minutes. In this way it is possible to obtain the desired degree of intercalation of the crosslinkable liquid composition between the lamellae of the inorganic lamellar compound, which cannot otherwise be obtained by simple mechanical mixing.

Alternatively, premixing may be carried out by subjecting to ultrasonic treatment at least one oligomer containing at least one reactive functional group, said oligomer preferably having a molecular weight of not less than 300 daltons, with said inorganic material with lamellar structure. Next, the other components of the composition (diluent monomer and photo-initiator) are added and the whole is conventionally mixed, for example by mechanical stirring.

The polymer material thus obtained is then subjected to crosslinking by working as described in the prior art. Said crosslinking may be carried out, for example, by exposure to UV radiation. The same degree of intercalation is maintained after the crosslinking.

The polymer material obtained is particularly useful as a secondary coating or common coating for an optical fibre. Said secondary coating generally surrounds a primary coating compatible therewith. For example, if the secondary coating is acrylic-based, the primary coating will also have to be acrylic-based.

Typically, an acrylic-based primary coating comprises at least one oligomer containing (meth)acrylate end groups, at least one diluent monomer of acrylic type and at least one photo-initiator.

The oligomer represents 40%-80% by weight of the crosslinkable composition. The oligomer is commonly obtained by reaction between a polyol structure, a polyisocyanate and a monomer bearing the function that is of interest in the crosslinking process. This function is preferably a (meth)acrylic group.

The molecular weight of the polyol structure is, for indicative purposes, between 500 and 6000 daltons; it may be entirely hydrocarbon, polyether, polyester, polysiloxane, fluorinated type, or a mixture thereof. The hydrocarbon and polyether structures and mixtures thereof are preferred. A representative structure of a polyether polyol may be, for example, polytetramethylene oxide, polymethyltetramethylene oxide, polymethylene oxide, polypropylene oxide, polybutylene oxide, isomers thereof, or mixtures thereof. Representative structures of a hydrocarbon polyol are polybutadiene and polyisobutylene, totally or partially hydrogenated and functionalized with hydroxyl groups.

The polyisocyanate may be of aromatic or aliphatic type. Examples of polyisocyanates are: isophorone diisocyanate, 1,6-hexamethylene diisocyanate, 2,2,4-trimethyl-1,5-pentamethylene diisocyanate, 3,3′-diphenylmethane diisocyanate, 4,4′-diphenylmethane diisocyanate, 2,4-toluene diisocyanate, 2,6-toluene diisocyanate.

The monomer bearing the acrylic function comprises groups capable of reacting with the isocyanic group. Examples that are suitable for this purpose are hydroxyalkyl (meth)acrylates such as, for example, hydroxyethyl (meth)acrylate or hydroxypropyl (meth)acrylate.

The diluent monomer represents 20%-50% by weight of the formulation and its main purpose is to give the crosslinkable composition a viscosity of about 5 Pa.s at coating-application temperature. The diluent monomer, bearing the reactive function, preferably of (meth)acrylic type, has a structure that is compatible with that of the oligomer. The diluent monomer may contain an alkyl structure such as, for example, isobornyl acrylate, hexane diacrylate, 1,6-hexanediol diacrylate, dicyclopentadiene acrylate, trimethylolpropane triacrylate; or an aromatic structure such as, for example, nonylphenyl ether acrylate, polyethylene glycol phenyl ether acrylate; or mixtures thereof.

The photo-initiator is necessary when the crosslinking is carried out by means of irradiation with UV rays. When the crosslinking is of radical type, the photo-initiator generally belongs to the class of α-hydroxy ketones, α-amino ketones, benzyldimethyl ketals, acylphosphine oxides, or mixtures thereof. The amount of photo-initiator generally corresponds to 1%-5% by weight of the composition.

For the purpose of improving the fundamental properties of the abovementioned composition for the primary coating, further additives may optionally be added. For example, glass-adhesion promoters, solvents, plasticizers, surfactants capable of improving the wetting of the coating on the glass portion of the optical fibre, expansion agents, devolatilizers, opacifiers, rheological agents, antioxidants, UV stabilizers capable of not interfering with the crosslinking operations, temperature-mediated polymerization inhibitors, levelling agents, detachment promoters as regards subsequent coatings, may be added. Organosilanes such as triethoxytrimethylmercaptosilane are commonly used as glass-adhesion promoters, in an amount of between 0.2 and 2%.

A typical crosslinkable liquid composition for a primary coating comprises about 50%-65% by weight of polyurethane acrylate, about 30%-50% by weight of reactive diluent monomer, about 0.5%-2% by weight of photo-initiator, about 0.5%-5% by weight of other additives.

Crosslinkable compositions for the primary coating of the type such as those described above that may be used in the present invention are commercially available, for example, under the brand name Desolite® from DSM (the Netherlands), such as, for example, the commercial composition Desolite® indicated by the code 3471-1-129.

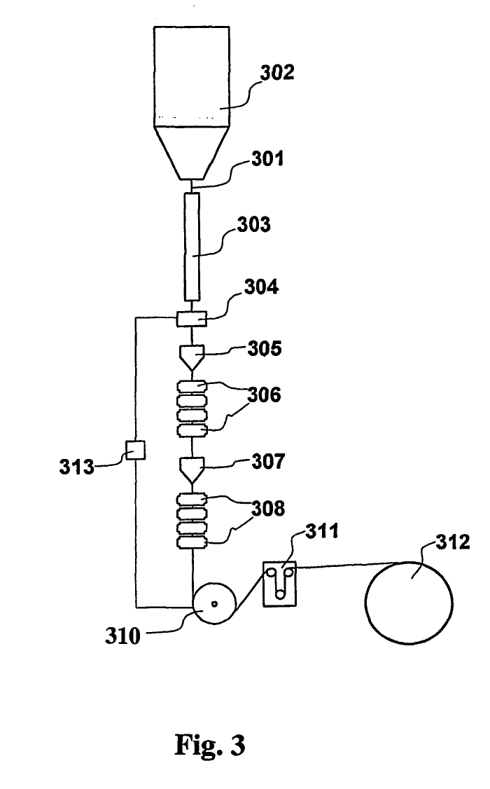

An optical fibre according to the present invention may be produced according to the usual spinning techniques by using, for example, a system such as the one illustrated diagrammatically in FIG. 3.

This system, commonly known as a “spinning tower”, typically comprises a furnace (302) inside which is placed a glass optical preform to be spun. The bottom part of said preform is heated to the softening point and spun into an optical fibre (301). The fibre is then cooled, preferably to a temperature of not less than 60° C., preferably in a suitable cooling tube (303) of the type described, for example, in patent application WO 99/26891, and passed through a diameter measurement device (304). This device is connected by means of a microprocessor (313) to a pulley (310) which regulates the spinning speed; in the event of any variation in the diameter of the fibre, the microprocessor (313) intervenes to regulate the rotational speed of the pulley (310), so as to keep the diameter of the optical fibre constant. Next, the fibre passes into a primary coating applicator (305), containing the coating composition in liquid form, and is covered with this composition to a thickness of about 25 μm-35 μm. The coated fibre is then passed into a UV oven (or a series of ovens) (306) in which the primary coating is crosslinked. The fibre covered with the crosslinked primary coating is then passed into a second applicator (307), in which it is coated with the secondary coating and then crosslinked in the relative UV oven (or series of ovens) (308). Alternatively, the application of the secondary coating may be carried out directly on the primary coating before the latter has been crosslinked, according to the “wet-on-wet” technique. In this case, a single applicator is used, which allows the sequential application of the two layers of coating, for example, of the type described in patent U.S. Pat. No. 4,474,830. The fibre thus covered is then crosslinked using one or more UV ovens similar to those used to crosslink the individual coatings.

Subsequent to the coating and to the crosslinking of this coating, the fibre may optionally be made to pass through a device capable of giving a predetermined twist to this fibre, for example of the type described in international patent application WO 99/67180, for the purpose of reducing the PMD (“Polarization Mode Dispersion”) value of this fibre. The pulley (310) placed downstream of the devices illustrated previously controls the spinning speed of the fibre. After this drawing pulley, the fibre passes through a device (311) capable of controlling the tension of said fibre, of the type described, for example, in patent application EP 1 112 979, and is finally collected on a reel (312).

An optical fibre thus produced may be used as such in the production of optical cables. Alternatively, several optical fibres with a conventional coating may be combined in a ribbon of several fibres combined together by means of a common polymer coating (“common coating”) that may be applied according to techniques known in the art, said common polymer coating optionally being obtained according to the present invention. The common polymer coating may be applied by arranging the optical fibres parallel to each other, passing them through a common polymer coating applicator (for example at a speed of 250-300 m/min) and crosslinking this coating using a suitable UV lamp.

The present invention will be further illustrated hereinbelow by means of a number of implementation examples that are provided purely as a guide and are non-limiting on the invention.

### EXAMPLE 1

### Preparation of Composition (A)

A test relating to the production of a composition was carried out by mixing together the following compounds, by means of ultrasonic treatment:
100 phr of Ebecryl® 150 (UCB) which corresponds to a high molecular weight bisphenol A diacrylate derivative;
5 phr of Cloisite® 30B (Southern Clay Products): organo-modified montmorillonite (90 meq/100 g) belonging to the smectite family.

The abovementioned compounds were placed in a 200 ml beaker and subjected to ultrasonic treatment, at a frequency of 47 KHz (±6%), at room temperature for 1 hour, using a Branson 2200 ultrasonicator.

The composition thus obtained was spread onto a glass support forming a layer 200 μm thick and 5 cm wide, and was subjected to X-ray diffraction analysis using a “Philips 'Xpert” diffractometer and working as described above. A d-spacing value equal to 36.1 Å was obtained.

Said value, compared with the d-spacing value for Cloisite® 30B powder which was equal to 18.2 Å, shows that the acrylate has become intercalated in the inorganic material: as a matter of fact, a 100% variation in the d-spacing value was obtained. Consequently, the use of a high molecular weight acrylate oligomer and a compatible inorganic material makes it possible to obtain a polymer material according to the invention.

### EXAMPLE 2

### Preparation of Compositions (B), (C) and (D)

A test relating to the production of compositions was carried out by mixing together the compounds given in Table 1, by means of ultrasonic treatment. The amounts of the compounds are expressed in phr.

TABLE 1

| | COMPOSITION | | |
|---|---|---|---|
| COMPOUND | (B)* | (C) | (D) |
| Ebecryl ® 210 | 24.0 | 23.3 | 22.6 |
| Ebecryl ® 150 | 11.0 | 10.7 | 10.3 |
| Ebecryl ® 3700 | 40.0 | 38.8 | 37.6 |
| Cloisite ® 30B | — | 3.1 | 6.0 |
| Isobornyl acrylate | 4.0 | 3.9 | 3.8 |
| 1,6-Hexanediol diacrylate | 19.8 | 19.2 | 18.6 |
| Irgacure ® 907 | 1.2 | 1.2 | 1.1 |

*comparative
Ebecryl ® 210: high molecular weight aromatic urethane diacrylate (UCB);
Ebecryl ® 150: high molecular weight bisphenol A diacrylate derivative (UCB);
Ebecryl ® 3700: high molecular weight bisphenol A epoxydiacrylate (UCB);
Cloisite ® 30B (Southern Clay Products): organo-modified montmorillonite (90 meq/100 g) belonging to the smectite family;
Irgacure ® 907: 2-methyl-1-[4-(methylthio)phenyl]-2-morpholinopropan-1-one (Ciba).

Compositions (C) and (D) were obtained by placing the abovementioned compounds in a 200 ml beaker and subjecting them to ultrasonic treatment at room temperature for 1 hour, using a Branson 2200 ultrasonicator.

Composition (B) (not containing the inorganic compound) was obtained by placing the abovementioned compounds in a 200 ml beaker and subjecting them to mechanical stirring at room temperature for 30 minutes, using a RW 28 stirrer from Ika Labortechnik.

Using the compositions obtained as described above, films were prepared by working as follows. A film 70 μm thick and 5 cm wide was spread onto a glass support using a device with a mobile micrometric calliper capable of giving the material a uniform thickness at a speed of 2 cm/sec (known in the art as a “Doctor Blade”). The film thus obtained was subjected to UV crosslinking using a Fusion UV curing system instrument, model MC6R and a lamp with spectrum H, applying a UV dose of 5000 mJ/cm². After the crosslinking, the film was removed from the glass.

The films thus obtained were subjected to X-ray diffraction analysis using a “Philips 'Xpert” diffractometer and working as described above. A d-spacing value equal to 34.68 Å was obtained.

Said value, compared with the d-spacing value for Cloisite® 30B powder which was equal to 18.2 Å, shows that the crosslinkable liquid composition has become intercalated in the inorganic material with lamellar structure: as a matter of fact, a 90% variation in the d-spacing value was obtained. Consequently, the use of a crosslinkable liquid composition and a compatible organic material also makes it possible to obtain a polymer material according to the present invention.

Mechanical Properties

The compositions obtained as described above were subjected to thermomechanical characterization using a DMTA device (Dynamic Mechanical Thermal Analyzer from Rheometrics Inc.).

To this end, films 300 μm thick and 5 cm wide were prepared with compositions (B), (C) and (D), working as described above. After the crosslinking, each film was removed from the glass and samples having the following dimensions: 15 mm×6 mm×0.3 mm, were punched out.

Said punch samples were attached by means of clamps at the two ends and subjected to traction with a sinusoidal course by means of the guide clamp, working at an oscillation frequency of between 0.033 Hz and 90 Hz and in a temperature range of between −150° C. and +300° C. The elongation of the punch sample is proportional to the current supplied to the vibrator connected to the clamp. The results of the DMTA analysis are given in Table 2.

Next, working as described above, films 70 μm thick and 5 cm wide were prepared. After crosslinking, each film was removed from the glass and samples having the following dimensions: 10 mm×15 mm×0.070 mm, were punched out and were used to determine the elongation at break and the stress at break using an Instron machine and working at a tensile speed of 25 mm/min.

The results obtained are given in Table 2.

Permeability Measurements

Table 2 also shows the water-vapour permeability values according to standard ASTM E96, measured at room temperature on films 200 μm thick and 5 cm wide obtained from compositions (B), (C) and (D) and working as described above.

TABLE 2

| | COMPOSITION | | |
|---|---|---|---|
| | (B)* | (C) | (D) |
| STRESS AT BREAK | 21.89 | 42.58 | 46.42 |
| (MPa) | | | |
| ELONGATION AT BREAK | 2.20 | 5.25 | 5.94 |
| (%) | | | |
| MODULUS OF | 350 | 450 | 600 |
| ELASTICITY AT ZERO | | | |
| ELONGATION AT 70° C. | | | |
| (MPa) | | | |
| PERMEABILITY | 2.75 · 10⁻⁸ | 2.36 · 10⁻⁸ | 1.69 · 10⁻⁸ |
| g/(cm · h · mmHg) | | | |

*comparative

The data given above show that compositions (C) and (D) have improved mechanical properties and, consequently, show a marked reinforcing effect due to the intercalation that has taken place, with respect to the comparative composition (B) not containing inorganic material.

In addition, the data given above show that the compositions according to the present invention have improved barrier properties. In particular, the data in Table 2 show a reduction in permeability to water vapour of about 40% for composition (D) with respect to the unmodified acrylate mixture [composition (B)].

### EXAMPLE 3 (COMPARATIVE)

### Preparation of Compositions (C′) and (D′)

A test relating to the production of compositions by mixing by means of mechanical stirring of the compounds given in Table 3, was carried out. The amounts of the compounds are expressed in phr.

TABLE 3

COMPOSITION

| COMPOUND | (C′) | (D′) |
|---|---|---|
| Ebecryl ® 210 | 23.3 | 22.6 |
| Ebecryl ® 150 | 10.7 | 10.3 |
| Ebecryl ® 3700 | 38.8 | 37.6 |
| Cloisite ® 30B | 3.1 | 6.0 |
| Isobornyl acrylate | 3.9 | 3.8 |
| 1,6-Hexanediol diacrylate | 19.2 | 18.6 |
| Irgacure ® 907 | 1.2 | 1.1 |

Ebecryl ® 210: high molecular weight aromatic urethane diacrylate (UCB);
Ebecryl ® 150: high molecular weight bisphenol A diacrylate derivative (UCB);
Ebecryl ® 3700: high molecular weight bisphenol A epoxydiacrylate containing hydroxyl functions (UCB);
Cloisite ® 30B (Southern Clay Products): organo-modified montmorillonite (90 meq/100 g) belonging to the smectite family;
Irgacure ® 907: 2-methyl-1-[4-(methylthio)phenyl]-2-morpholinopropan-1-one (Ciba).

Compositions (C′) and (D′) were obtained by placing the abovementioned compounds in a 200 ml beaker and subjecting them to mechanical stirring at room temperature for 1 hour, using an RW 28 stirrer from Ika Labortechnik.

Using the compositions obtained as described above, films were prepared by working as described in Example 2.

The crosslinked films thus obtained were subjected to X-ray diffraction analysis using a “Philips 'Xpert” diffractometer and working as described above. A d-spacing value equal to 18.2 Å was obtained.

Said value, compared with the d-spacing value for Cloisite® 30B powder which was equal to 18.2 Å, shows that there was no intercalation of the acrylate mixture into the inorganic material. Consequently, a mixing of mechanical type does not make it possible to obtain a polymer material according to the invention.

Mechanical Properties

The samples obtained as described above were subjected to mechanical characterization, working as described in Example 2.

The results obtained are given in Table 4, in which the values for composition (B) (containing no inorganic compound) are given for comparative purposes).

TABLE 4

| | COMPOSITION | | |
|---|---|---|---|
| | (B)* | (C′) | (D′) |
| STRESS AT BREAK | 21.89 | 21.20 | 20.92 |
| (MPa) | | | |
| ELONGATION AT BREAK | 2.20 | 1.67 | 1.59 |
| (%) | | | |
| MODULUS OF ELASTICITY AT | 350 | 380 | 392 |
| ZERO ELONGATION AT 70° C. | | | |
| (MPa) | | | |

*comparative

The data given above show that compositions (C′) and (D′) do not have improved mechanical properties with respect to composition (B) containing no inorganic material.

1. An optical fibre comprising a glass portion and at least one coating of crosslinked polymer material surrounding said glass portion, said coating being obtained by crosslinking a mixture comprising:
at least one crosslinkable liquid composition comprising at least one oligomer containing at least one reactive functional group, at least one diluent monomer capable of reacting with said reactive functional group and at least one photo-initiator; and
at least one inorganic material with lamellar structure formed by a plurality of lamellae that have been surface-treated beforehand with a compatibilizer;
said coating formed by said crosslinked liquid composition intercalated between the lamellae of said inorganic material.

2. The optical fibre according to claim 1, in which said coating is a secondary coating surrounding a primary coating.

3. The optical fibre according to claim 1, in which said coating may be obtained by subjecting said mixture to ultrasonic treatment followed by crosslinking.

4. The optical fibre according to claim 1, in which said coating may be obtained by subjecting at least said oligomer and said inorganic material with lamellar structure to ultrasonic treatment, mixing the remaining components of the abovementioned crosslinkable liquid composition, and then crosslinking the mixture thus obtained.

5. The optical fibre according to claim 1, in which the crosslinkable liquid composition comprises at least one oligomer containing a (meth)acrylate end group, at least one diluent monomer of acrylic type and at least one photo-initiator.

6. The optical fibre according to claim 5, in which the oligomer containing at least one (meth)acrylate end group has a molecular weight of less than 300 daltons.

7. The optical fibre according to claim 1, in which the crosslinkable liquid composition comprises about 40%-70% by weight of polyurethane acrylate, epoxy acrylate or a mixture thereof, about 30%-50% by weight of diluent monomer, about 1%-5% by weight of photo-initiator, and about 0.5%-5% by weight of other additives.

8. The optical fibre according to claim 1, in which the polymer material has a d-spacing value by X-ray diffraction analysis that is at least 20% greater than the d-spacing value of the inorganic material that has been surface-treated with a compatibilizer per se.

9. The optical fibre according to claim 1, in which said polymer material has a modulus of elasticity at 70° C. of between 20 MPa and 1000 MPa.

10. The optical fibre according to claim 9, in which said polymer material has a modulus of elasticity at 70° C. of between 100 MPa and 700 MPa.

11. The optical fibre according to claim 1, in which said polymer material has a glass transition temperature (T_{g}) of between 75° C. and 85° C.

12. The optical fibre according to claim 11, in which said polymer material has a glass transition temperature (T_{g}) of between 79° C. and 82° C.

13. The optical fibre according to claim 1, in which the compatibilizer is selected from quaternary ammonium and phosphonium salts of general formula (I): 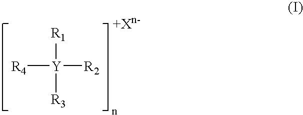
in which:
Y represents N or P;
R₁, R₂, R₃ and R₄, which may be identical or different, represent a linear or branched C₁-C₂₀ alkyl or hydroxyalkyl group; a linear or branched C₁-C₂₀ alkenyl or hydroxyalkenyl group; a group —R₅—SH or —R₅—NH in which R₅ represents a linear or branched C₁-C₂₀ alkylene group; a C₆-C₁₈ aryl group; a C₇-C₂₀ arylalkyl or alkylaryl group; or a C₅-C₁₈ cycloalkyl group;
Xⁿ⁻ represents an anion; and
n represents 1, 2 or 3.

14. The optical fibre according to claim 13, in which the compatibilizer is present in an amount of between 80 meq and 100 meq per 100 g of inorganic material with lamellar structure.

15. The optical fibre according to claim 1, in which the inorganic material with lamellar structure is present in an amount of between 1 phr and 40 phr.

16. The optical fibre according to claim 15, in which the inorganic material with lamellar structure is present in an amount of between 4 phr and 20 phr.

17. The optical fibre according to claim 3 or 4, in which the ultrasonic treatment is carried out at a frequency of between 20 KHz and 60 KHz.

18. The optical fibre according to claim 17, in which the ultrasonic treatment is carried out at a frequency of between 50 KHz and 55 KHz.

19. The optical fibre according to claim 18, in which the ultrasonic treatment is carried out at a frequency of between 45 KHz and 50 KHz.

20. The optical fibre according to claim 3 or 4, in which the ultrasonic treatment is carried out for a period of between 5 minutes and 60 minutes.

21. The optical fibre according to claim 20, in which the ultrasonic treatment is carried out for a period of between 15 minutes and 60 minutes.

22. A ribbon of optical fibres arranged in parallel and enclosed is a common coating of crosslinked polymer material, said coating being obtained by crosslinking a mixture comprising:
at least one crosslinkable liquid composition comprising at least one oligomer containing at least one reactive functional group, at least one diluent monomer capable of reacting with said reactive functional group and at least one photo-initiator; and
at least one inorganic material with lamellar structure formed by a plurality of lamellae that have been surface-treated beforehand with a compatibilizer;
said coating is formed by said crosslinked liquid composition intercalated between the lamellae of said inorganic material.

23. The ribbon of optical fibres according to claim 22, in which said coating may be obtained by subjecting said mixture to ultrasonic treatment followed by crosslinking.

24. The ribbon of optical fibres according to claim 22, in which said coating may be obtained by subjecting at least said oligomer and said inorganic material with lamellar structure to ultrasonic treatment, mixing the remaining components of the abovementioned crosslinkable liquid composition, and then crosslinking the mixture thus obtained.

25. The ribbon of optical fibres according to claim 22, in which the crosslinkable liquid composition comprises at least one oligomer containing (meth)acrylate end group, at least one diluent monomer of acrylic type and at least one photo-initiator.

26. The ribbon of optical fibres according to claim 22, in which the polymer material has a d-spacing value of X-ray diffraction analysis that is at least 20% greater than the d-spacing value of the inorganic material that has been surface-treated beforehand with a compatiblizer per se.

27. The ribbon of optical fibres according to claim 22, in which said polymer material has a modulus of elasticity at 70° C. of between 20 MPa and 1000 MPa.

28. The ribbon of optical fibres according to claim 22, in which said polymer material has a glass transition temperature (T_{g}) of between 75° C. and 85° C.

29. (canceled)

30. The ribbon of optical fibres according to claim 23 or 24, in which the ultrasonic treatment is carried out at a frequency of between 20 Khz and 60 KHz for a period of between 5 minutes and 120 minutes.

31. A polymer material which may be obtained by ultrasonic treatment and then crosslinking a mixture comprising:
at least one crosslinkable liquid composition comprising at least one oligomer containing at least one reactive functional group, at least one diluent monomer capable of reacting with said reactive functional group and at least one photo-initiator; and
at least one inorganic material with lamellar structure formed by a plurality of lamellae that have been surface-treated beforehand with a compatibilizer;
said polymer material is formed by said crosslinked liquid composition intercalated between the lamellae of said inorganic material.

32. The polymer material according to claim 31, in which said polymer material may be obtained by subjecting at least said oligomer and said inorganic material with lamellar structure to ultrasonic treatment, mixing the remaining components of the abovementioned crosslinkable liquid composition, and then crosslinking the mixture thus obtained.

33. The polymer material according to claim 31, in which the crosslinkable liquid composition comprises at least one oligomer containing a (meth)acrylate end group, at least one diluent monomer of acrylic type and at least one photo-initiator.

34. The polymer material according to claim 31, in which the polymer material has a d-spacing value by X-ray diffraction analysis that is at least 20% greater than the d-spacing value of the inorganic material that has been surface-treated beforehand with a compatibilizer per se.

35. The polymer material of claim 31, in which said polymer material has a modulus of elasticity at 70° C. of between 20 MPa and 1000 MPa.

36. The polymer material of claim 31, in which said polymer material has a glass transition temperature (T_{g}) of between 75° C. and 85° C.

37. (canceled)

38. The polymer material of claim 31 or 32, in which the ultrasonic treatment is carried out at a frequency of between 20 KHz and 60 KHz for a period of between 5 minutes and 120 minutes.

39. A method for preparing a crosslinkable polymer material, in which a crosslinkable liquid composition is intercalated between the lamellae of an inorganic compound of lamellar structure, said method comprising the ultrasonic treatment of a mixture comprising:
at least one crosslinkable liquid composition comprising at least one oligomer containing at least one reactive functional group, at least one diluent monomer capable of reacting with said reactive functional group and at least one photo-initiator; and
at least one inorganic material with lamellar structure formed by a plurality of lamellae that have been surface-treated beforehand with a compatibilizer.

40. The method according to claim 39, which may be obtained by subjecting at least said oligomer and said inorganic material with lamellar structure to ultrasonic treatment and mixing the remaining components of the crosslinkable liquid composition.

41. The method according to claim 39, in which the crosslinkable liquid composition comprises at least one oligomer containing a (meth)acrylate end group, at least one diluent monomer of acrylic type and at least one photo-initiator.

42. (canceled)

43. The method according to claim 39 or 40, in which the ultrasonic treatment is carried out at a frequency of between 20 KHz and 60 KHz for a period of between 5 minutes and 120 minutes.

44. The optical fibre according to claim 13, wherein the cycloalkyl group contains a hetero atom.

45. The optical fibre according to claim 44, wherein the hetero atom is oxygen, nitrogen or sulphur.

46. The optical fibre according to claim 13, wherein the anion is a chloride ion, a sulphate ion or a phosphate ion.

47. The optical ribbon according to claim 25, in which the oligomer containing at least one (meth)acrylate end group has a molecular weight of less than 300 daltons.

48. The optical ribbon according to claim 22, in which the crosslinkable liquid composition comprises about 40%-70% by weight of polyurethane acrylate, epoxy acrylate or a mixture thereof, about 30%-50% by weight of diluent monomer, about 1%-5% by weight of photo-initiator, and about 0.5%-5% by weight of other additives.

49. The ribbon of optical fibers according to claim 22, wherein the compatibilizer is selected from a quaternary ammonium and phosphonium salts of general formula (I): 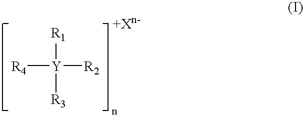
in which:
Y represents N or P;
R₁, R₂, R₃ and R₄, which may be identical or different, represent a linear or branched C₁-C₂₀ alkyl or hydroxyalkyl group; a linear or branched C₁-C₂₀ alkenyl or hydroxyalkenyl group; a group —R₅—SH or —R₅—NH in which R₅ represents a linear or branched C₁-C₂₀ alkylene group; a C₆-C₁₈ aryl group; a C₇-C₂₀ arylalkyl or alkylaryl group; or a C₅-C₁₈ cycloalkyl group;
Xⁿ⁻ represents an anion; and
n represents 1, 2, or 3.

50. The ribbon of optical fibres according to claim 49, wherein the cycloalkyl group contains a hetero atom selected from oxygen, nitrogen or sulphur.

51. The ribbon of optical fibres according to claim 49, wherein the anion is a chloride ion, a sulphate ion or a phosphate ion.

52. The ribbon of optical fibres according to claim 49, wherein the compatibilizer is present in an amount of between 80 meq and 100 meq per 100 g of inorganic material with lamellar structure.

53. The ribbon of optical fibres according to claim 22, wherein the inorganic material is lamellar structure is present in an amount of between 1 phr and 40 phr.

54. The polymer material according to claim 33, wherein the oligomer containing at least one (meth) acrylate end has a molecular weight of less than 300 daltons.

55. The polymer material according to claim 31, wherein the crosslinkable liquid composition comprises about 40%-70% by weight of polyurethane acrylate, epoxy acrylate or a mixture thereof, about 30%-50% by weight of diluent monomer, about 1%-5% by weight of photo-initiator, and about 0.5%-5% by weight of other additives.

56. The polymer material according to claim 31, wherein the compatibilizer is selected from a quaternary ammonium and phosphonium salts of general formula (I): 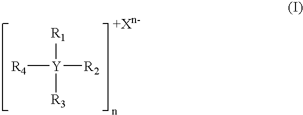
in which:
Y represents N or P;
R₁, R₂, R₃ and R₄, which may be identical or different, represent a linear or branched C₁-C₂₀ alkyl or hydroxyalkyl group; a linear or branched C₁-C₂₀ alkenyl or hydroxyalkenyl group; a group —R₅—SH or —R₅—NH in which R₅ represents a linear or branched C₁-C₂₀ alkylene group; a C₆-C₁₈ aryl group; a C₇-C₂₀ arylalkyl or alkylaryl group; or a C₅-C₁₈ cycloalkyl group;
Xⁿ⁻ represents an anion; and
n represents 1, 2, or 3.

57. The polymer material according to claim 56, wherein the cycloalkyl group contains a hetero atom selected from oxygen, nitrogen or sulphur.

58. The polymer material according to claim 56, wherein the anion is a chloride ion, a sulphate ion or a phosphate ion.

59. The polymer material according to claim 56, wherein the compatibilizer is present in an amount of between 80 meq and 100 meq per 100 g of inorganic material with lamellar structure.

60. The polymer material according to claim 31, wherein the inorganic material with lamellar structure is present in an amount of between 1 phr and 40 phr.

61. The method according to claim 41, wherein the oligomer containing at least one (meth)acrylate end group has a molecular weight of less than 300 daltons.

62. The method according to claim 39, wherein the compatibilizer is selected from a quaternary ammonium and phosphonium salts of general formula (I): 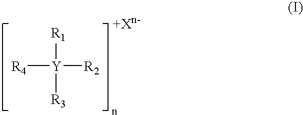
in which:
Y represents N or P;
R₁, R₂, R₃ and R₄, which may be identical or different, represent a linear or branched C₁-C₂₀ alkyl or hydroxyalkyl group; a linear or branched C₁-C₂₀ alkenyl or hydroxyalkenyl group; a group —R₅—SH or —R₅—NH in which R₅ represents a linear or branched C₁-C₂₀ alkylene group; a C₆-C₁₈ aryl group; a C₇-C₂₀ arylalkyl or alkylaryl group; or a C₅-C₁₈ cycloalkyl group;
Xⁿ⁻ represents an anion; and
n represents 1, 2, or 3.

63. The method according to claim 62, wherein the compatibilizer is present in an amount of between 80 meq and 100 meq per 100 g of inorganic material with lamellar structure.

64. The method according to claim 39, wherein the inorganic material with lamellar structure is present in an amount of between 1 phr and 40 phr.
